(19) United States
(12) Patent Application Publication
(10) Pub. No.: US 2006/0199420 A1
(43) Pub. Date: Sep. 7, 2006

(54) Cable end connector

(76) Inventors: Shu Man Chiang, Tucheng City (TW); Chung Hsin Huang, Tucheng City (TW); Huang Chi Chuan, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/072,319

(22) Filed: Mar. 7, 2005

(51) Int. Cl. H01R 4/24

(52) U.S. Cl. 439/395

(57) ABSTRACT

A cable end connector is provided. The cable end connector includes an electrical connector, a cable set in the back of the electrical connector, the cable being electronically connected with the electrical connector, and an over-mold cover formed outside of the cable and the electrical connector. A plurality of grooves is foamed on a surface of the insulation member. The bottom shell encloses the insulation member. Accordingly, the outside mold cover is formed around the electrical connector and the cable, whereby melting plastic flows from the top notches of the grooves into the grooves during molding. As a result, the outside mold cover is secured with the insulation member fixedly by use of cooled melting plastic, so that the outside mold cover and the insulation member are assembled fixedly.

### BACKGROUND OF THE INVENTION

1. Field of the Invention

The present invention relates to a cable end connector, and more particularly, to a cable end connector with an insulation member and an outside mold cover.

2. The Related Art

It is quite common that there are two methods to make cable end connectors. One is to put the joint portion of a cable and an electrical connector into a mold with plastic injected into the mold to form a card end connector as a whole, which mainly used to make small-volume cable end connectors. The other is to make a pair of outside covers engaged with each other in order to enclose the joint portion of a cable and an electrical connector in the covers. In the first method, after the cable is connected with the electrical connector, a plastic inner mold cover is formed as a whole in the back of the electrical connector in order to make the cable connected with the electrical connector as a whole, then an outside mold cover is formed outside of the inner mold cover as a whole to get the total cable end connector.

In the above-mentioned cable end connector, there is no connecting component between the over-mold cover and the electrical connector, so that the over-mold cover around the cable and the electrical connector would turn over due to drawing the cable for a long time. Especially, it would release the engagement between the cable and the electrical connector at the front margin of the over-mold cover.

### SUMMARY OF THE INVENTION

To solve the above mentioned problem, the present invention provides a cable end connector. The cable end connector comprises an electrical connector, a cable set in the back of the cable end connector and connected with the connector, and an over-mold cover surrounding the electrical connector and the outside surface of the cable. The electrical connector comprises an insulation member, a plurality of terminals set on the insulation member, a pair of latch slices set on the insulation member and a bottom shell enclosing the back of the insulation member. A plurality of grooves is formed on a surface of the insulation member to be covered by the outside mold cover. When the bottom shell is engaged with the insulation member, only the top of the grooves are not covered to be exposed outside of the bottom shell to form a notch. The appearance of the cable end connector is not changed. The outside mold cover is fixedly connected with the insulation member, so that the outside mold cover would not be released from the insulation member.

Accordingly, in the present invention, the outside mold cover is formed around the electrical connector and the cable, in the mean while melting plastic flows from the top notches of the grooves to stay in the grooves. In the result, the outside mold cover is fixedly secured with the insulation member by use of cooled melting plastic, so that the outside mold cover and the insulation member are assembled fixedly.

### BRIEF DESCRIPTION OF THE DRAWINGS

FIG. 1 is an exploded perspective view of an electrical connector of a preferred cable end connector.

FIG. 2 is a perspective view showing an outside cover engaged with a cable and an inner-mold cover separated.

FIG. 3 is a perspective view of the electrical connector of the cable end connector.

FIG. 4 is a side cross-sectional view of the electrical connector of the cable end connector.

FIG. 5 is a perspective view of the cable end connector.

### DETAILED DESCRIPTION OF THE PREFERRED EMBODIMENT

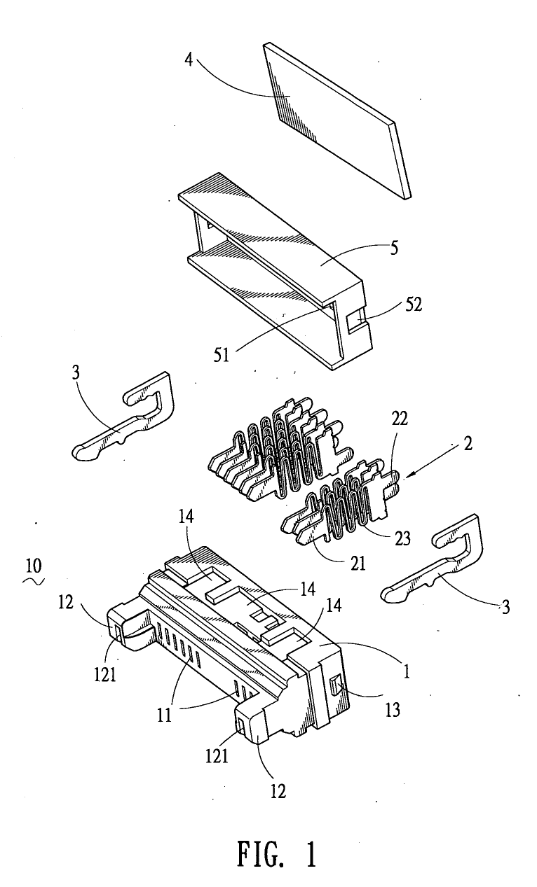

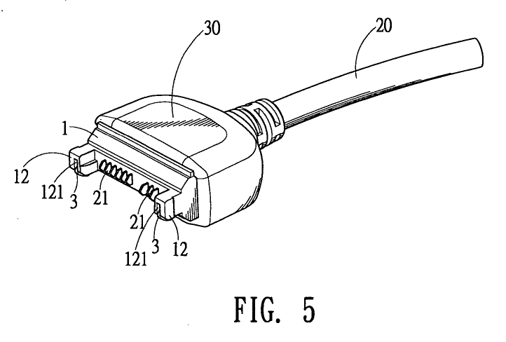

Please refer to FIGS. 1 and 5. A cable end connector 100 of the present invention comprises an electrical connector 10, a cable 20 and an over-mold cover 30 surrounding the electrical connector 10 and the outside surface of the cable 20. The cable 20 is set in the back of the electrical connector 10 and connected electronically with the electrical connector 10.

The electrical connector 10 has an insulation member 1, which defines two long borders and two short borders. A plurality of pin channels 11 is extended from the front of the insulation member 1 to the back of the insulation member 1. A guide bar 12 is protruded from the two sides of the front of the insulation member 1. A groove channel 121 is set on the guide bar 12 and extended from the front to the back of the guide bar 12. A plurality of latch members 13 are respectively set on the two short borders of the insulation member 1.

A plurality of terminals 2 and a pair of latch slices 3 are set on the insulation member 1. The terminals 2 are inserted into the insulation member 1 from the pin channel 11. Every terminal 2 comprises a contact portion 21 in the front a solder portion 22 in the back and a spring portion 23 therebetween. The contact portion 21 is exposed at the front of the insulation member 1 in order to connect a mated electrical connector (not shown). The solder portion 22 is exposed at the back of the insulation member 1 and connected with a printed circuit board 4. The latch slices 3 are respectively inserted from the groove channel 121 into the bottom of the insulation member 1. The head of the latch slices 3 are protruded from the groove channel 121 in the front of the guide bar 12 in order to engage with the mated electrical connector. The rear of the latch slices 3 is inserted in the printed board 4 for locating.

Please further refer to FIG. 1. The electrical connector 10 engages with a bottom shell 5 at the back of the insulation member 1. A plurality of apertures 51 is set on the bottom of the bottom shell 5 corresponding to the solder portion 22 of the terminal 2. When the bottom shell 5 is detained with the insulation member 1, the solder portion 22 of the terminal 2 can pass through the apertures 51. The bottom shell 5 has embedded apertures 52 on both sides, which engages with the latch member 13 of the insulation member 1.

According to the present invention, a plurality of grooves 14 is formed on a surface of the insulation member 1. When the bottom shell 5 encloses the insulation member 1, only the top of the grooves 14 is not closed and exposes to the outside of the bottom shell 5 to form nicks. The grooves 14 are located within the over-mold cover 30. In the preferred embodiment, the grooves 14 are set on the long sides of the insulation member 1. When an over-mold cover 30 is shaped, melting plastic can flow from the top nicks of the grooves 14 to coagulate in the grooves 14.

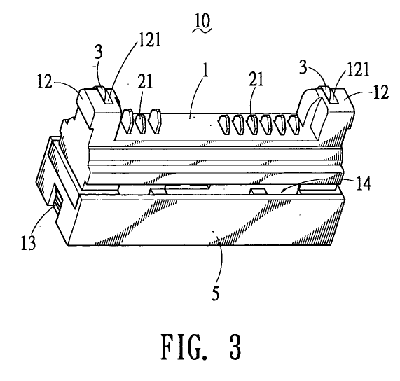

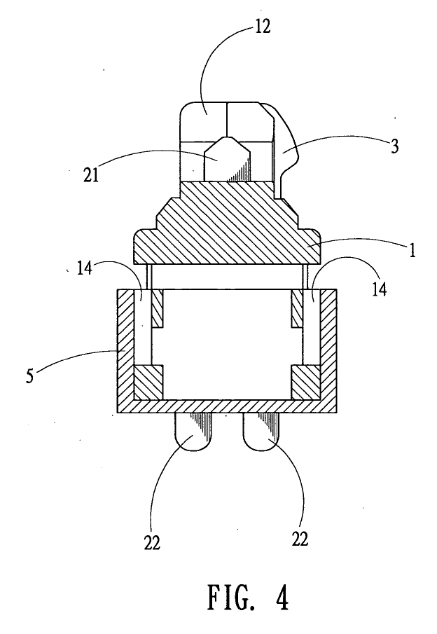

Please refer to FIGS. 1 to 4. When the cable end connector 100 is assembled, the terminal 2 is inserted in the pin channel 11 of the insulation member 1. The latch slices 3 are inserted in the groove channel 121. Then the bottom shell 5 is engaged with the insulation member 1 from the back of the insulation member 1, so that the solder portions 22 of the terminals 2 passes through the apertures 51 of the bottom shell 5. And then, the latch members 13 on the short sides of the insulation member 1 extend into the embedded apertures 52 of the bottom shell 5 in order to fixedly retain the bottom shell 5 on the insulation member 1 and to enclose the side border of the grooves 14 in the bottom shell 5 with the top of the grooves 14 open.

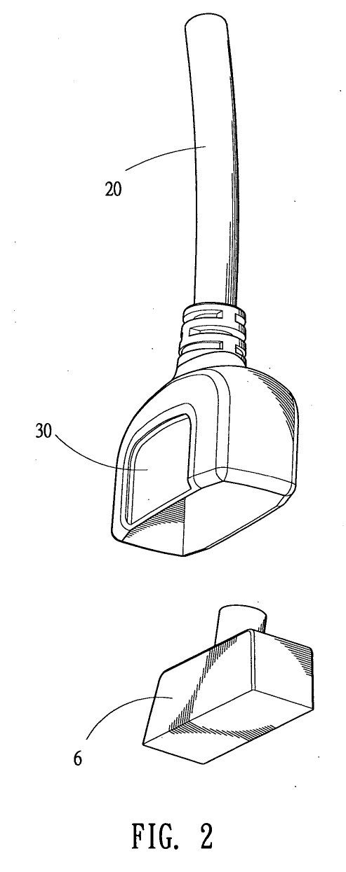

The solder portions 22 of the terminals 2 are welded with the printed circuit board 4 to fixedly retain the printed board 4 on the bottom of the bottom shell 5. Then, one end of the cable 20 welds with the printed board 4 in order to be electronically connected with the terminals 2. As shown in FIG. 2, an inner-mold cover 6 is shaped around the front end of the cable 20 to retain the electrical connector 10 with the cable 20. Finally, the over-mold cover 30 is shaped over the insulation member 1 and the cable 20 to stably connect the electrical connector 10 with the cable 10 by means of the good retaining power between the insulation member 1 and the cable 20. In the molding operation, melting plastic not only flows around the insulation member 1 and the outsider of the cable 20 to form the over-mold cover 30, but also flows into the grooves 14 to make the over-mold cover 30 retained with the insulation member 1.

In accordance with the present invention, the grooves 14 are arranged on the insulation member 1. Accordingly, during the melting period of forming the over-mold cover 30, melting plastic flows into the grooves 14 to retain the formed over-mold cover 30 with the insulation member 1 fixedly, consequently to avoid releasing the over-mold 30.

1. A cable end connector comprising:
an electrical connecter which comprises an insulation member, a plurality of terminals set on the insulation member, a pair of latch slices set on the insulation member and a bottom shell enclosing the back of the insulation member;
a cable set in the back of the electrical connector, the cable being electronically connected with the electrical connector;
an over-mold cover formed to extend about the cable and the electrical connector, the insulation member and bottom shell being at least partially embedded within the over-mold cover;
wherein the insulation member has a plurality of grooves formed on a surface of the insulation member, when the bottom shell encloses the insulation member, the grooves defining pockets within the bottom shell retentively filled by portions of the over-mold cover.

2. The cable end connector as claimed in claim 1, wherein latch members are respectively set on two short borders of the insulation member, and the bottom shell has a plurality of apertures set on both sides thereof to engage with the corresponding latch member of the insulation member.

3. The cable end connector as claimed in claim 1, wherein a plurality of terminals are inserted into the insulation member from the pin channel in the back of the terminals, each terminal comprises a contact portion in the front, a solder portion in the back and a spring portion therebetween, the contact portion exposes from the front of the insulation member in order to connect an electrical connector, the solder portion exposes from the back of the insulation member and connects with a printed circuit board.

4. The cable end connector as claimed in claim 1, wherein a plurality of apertures are set on the bottom of the bottom shell corresponding to the terminals.
